(19) United States
(12) Patent Application Publication
(10) Pub. No.: US 2021/0189272 A1
(43) Pub. Date: Jun. 24, 2021

(54) Combustible Cooking Brick and Cover Device Assembly

(71) Applicant: Sherinotta Williams, Detroit, MI (US)

(72) Inventor: Sherinotta Williams, Detroit, MI (US)

(21) Appl. No.: 16/722,534

(22) Filed: Dec. 20, 2019

(51) Int. Cl. C10L 5/36

(52) U.S. Cl. CPC C10L 5/36

(57) ABSTRACT

A combustible cooking brick and cover device assembly for controlled and mess-free grilling includes a combustible cooking brick and a cover device. The combustible cooking brick comprises crushed charcoal and at least 2% lighter fluid by weight. The brick is rectangular prismatic and proportioned to fit within a standard barbeque grill. A cover device comprises a lid body having an upper face and a sidewall extending outward and downward from a perimeter of the upper face. The sidewall and the upper face define a lid interior dimensioned to contain the combustible cooking brick. A handle is coupled to the lid body and a lip is coupled to the lid body. The lip horizontally extends from a lower edge of the sidewall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooking devices and more particularly pertains to a new cooking device for controlled and mess-free grilling.

### (2) Description of Related Art Including Information Disclosed Under 37 CFR 1.97 and 1.98

The prior art relates to cooking devices and artificial logs. Existing artificial logs and fire starters are intended for use in fireplaces and firepits for warmth and not for use with a cooking grill. Such prior art is typically not dimensioned to fit within a grill and is not capable of being extinguished and reused. Furthermore, much of the prior art includes material such as paraffin and sawdust not fit for cooking food for human consumption. Existing charcoal briquettes typically used for grilling are messy and cannot be extinguished and reused. They may also be difficult to light and create temperature control problems within the grill for inexperienced cooks.

### BRIEF SUMMARY OF THE INVENTION

An embodiment of the disclosure meets the needs presented above by generally comprising a combustible cooking brick and a cover device. The combustible cooking brick comprises at least 75% crushed charcoal and at least 2% lighter fluid by weight. The brick is rectangular prismatic and proportioned to fit within a standard barbeque grill. A cover device comprises a lid body having an upper face and a sidewall extending outward and downward from a perimeter of the upper face. The sidewall and the upper face define a lid interior dimensioned to contain the combustible cooking brick. A handle is coupled to the lid body and a lip is coupled to the lid body. The lip horizontally extends from a lower edge of the sidewall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a combustible cooking brick and cover device assembly according to an embodiment of the disclosure.

FIG. 2 is a detail view of an embodiment of the disclosure.

FIG. 3 is a front elevation view of an embodiment of the disclosure.

FIG. 4 is a bottom plan view of an embodiment of the disclosure.

### DETAILED DESCRIPTION OF THE INVENTION

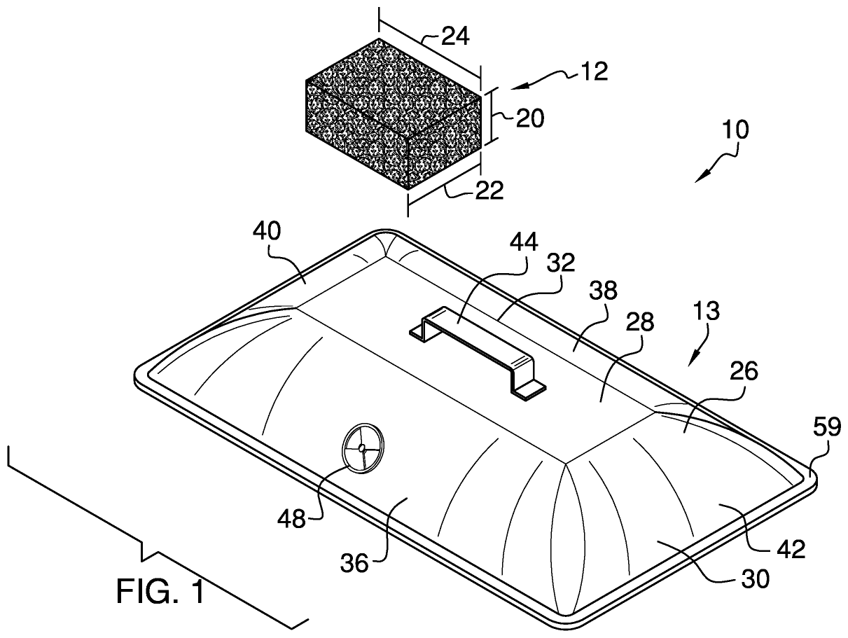

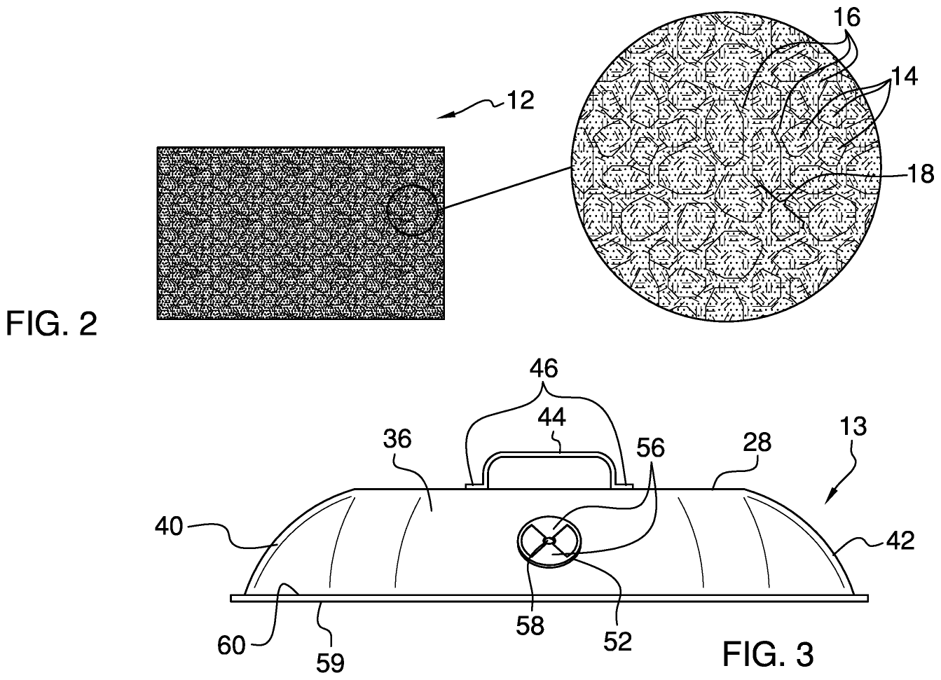

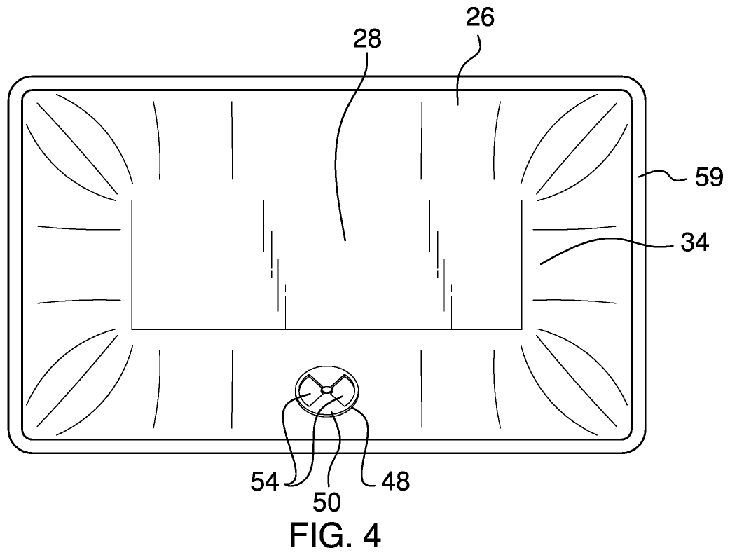

With reference now to the drawings, and in particular to FIGS. 1 through 4 thereof, a new cooking device embodying the principles and concepts of an embodiment of the disclosure and generally designated by the reference numeral 10 will be described.

As best illustrated in FIGS. 1 through 4, the combustible cooking brick and cover device assembly 10 generally comprises a combustible cooking brick 12 and a cover device 13. The combustible cooking brick 12 comprises 75-88% crushed charcoal 14, 10-20% woodchips 16, and at least 2% lighter fluid 18 by weight. The lighter fluid 18 makes the brick 12 easy to ignite and to burn continuously and evenly. The woodchips 16 may be, but are not limited to, apple, hickory, maple, birch, mesquite and the like to add flavor. The brick 12 is rectangular prismatic and proportioned to fit within a standard barbeque grill. The combustible cooking brick 12 has a height 20, a width 22, and a length 24 that may be proportioned in a ratio of 3:5:7 to produce various sizes of bricks 12.

The cover device 13 comprises a lid body 26 having an upper face 28 and a sidewall 30 extending outward and downward from a perimeter 32 of the upper face. The sidewall 30 and the upper face 28 define a lid interior 34 dimensioned to contain the combustible cooking brick 12. The upper face 28 may be rectangular and planar to minimize the required size to cover the brick 12. The sidewall 30 may be curved concave relative the lid interior 34 to create space around the brick 12. The sidewall 30 may comprise a front portion 36, a back portion 38, a left portion 40, and a right portion 42. A handle 44 is coupled to the lid body 26 to allow the user to cover and remove the cover device from the brick 12. The handle 44 may have a pair of tongues 46 to increase the surface area to contact the upper face 28 of the lid body. The handle 44 is a material with low thermal conductivity to prevent the user from being burned.

An adjustable vent 48 is coupled to the lid body 26 through the front portion 36 to allow a variable amount of airflow through to the lid interior 34. When the vent 48 is closed the lid body 26 is used to extinguish the brick 12 by cutting off oxygen. The vent 48 may be opened to control the burn rate and temperature of the brick 12. The vent 48 may have a circular mount 50 recessed within the front portion 36 and a vent cover 52 pivotably coupled to the mount 50. The mount 50 has a pair of vent apertures 54 extending through to the lid interior 34. The vent cover 52 has a pair of wings 56 extending from a central pivot 58. The pair of wings 56 conform to a shape of the pair of vent apertures 54 to fully cover the vent apertures 54 in the closed position. By rotating the vent cover 52 the wings 56 gradually expose the vent apertures 54 until they are fully exposed. Each vent aperture 54 may be sector-shaped. A lip 59 is coupled to the lid body 26. The lip 59 horizontally extends from a lower edge 60 of the sidewall to create a larger surface area to support the lid body 26.

In use, the block 12 is ignited and placed in a barbeque. The cover device 13 may be placed over the block 12 to control the burn rate and temperature. When done cooking, the cover device 13 is placed over the block 12 with the vent 48 in the closed position to extinguish the block to be saved for later use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combustible cooking brick and cover device assembly comprising:
a combustible cooking brick comprising at least 75% crushed charcoal and at least 2% lighter fluid by weight, the brick being rectangular prismatic and configured to fit within a barbeque grill; and
a cover device comprising:
a lid body, the lid body having an upper face and a sidewall extending outward and downward from a perimeter of the upper face, the sidewall and the upper face defining a lid interior dimensioned to contain the combustible cooking brick;
a handle coupled to the lid body; and
a lip coupled to the lid body, the lip horizontally extending from a lower edge of the sidewall.

2. The combustible cooking brick and cover device assembly of claim 1 further comprising the combustible cooking brick comprising 10-20% woodchips.

3. The combustible cooking brick and cover device assembly of claim 1 further comprising the combustible cooking brick having a height, a width, and a length proportioned in a ratio of 3:5:7.

4. The combustible cooking brick and cover device assembly of claim 1 further comprising the upper face of the lid body being rectangular and planar, the sidewall being curved concave relative the lid interior and having a front portion, a back portion, a left portion, and a right portion.

5. The combustible cooking brick and cover device assembly of claim 4 further comprising an adjustable vent coupled through the front portion, the vent allowing a variable amount of airflow through to the lid interior.

6. The combustible cooking brick and cover device assembly of claim 5 further comprising the vent having a circular mount recessed within the front portion and a vent cover pivotably coupled to the mount, the mount having a pair of vent apertures extending through to the lid interior, the vent cover having a pair of wings extending from a central pivot, the pair of wings conforming to a shape of the pair of vent apertures.

7. The combustible cooking brick and cover device assembly of claim 6 further comprising each vent aperture being sector-shaped.

8. A combustible cooking brick and cover device assembly comprising:
a combustible cooking brick comprising 75-88% crushed charcoal, 10-20% woodchips, and at least 2% lighter fluid by weight, the brick being rectangular prismatic and configured to fit within a barbeque grill, the combustible cooking brick having a height, a width, and a length proportioned in a ratio of 3:5:7; and
a cover device comprising:
a lid body, the lid body having an upper face and a sidewall extending outward and downward from a perimeter of the upper face, the sidewall and the upper face defining a lid interior dimensioned to contain the combustible cooking brick, the upper face being rectangular and planar, the sidewall being curved concave relative the lid interior and having a front portion, a back portion, a left portion, and a right portion;
an adjustable vent coupled to the lid body, the adjustable vent being coupled through the front portion and allowing a variable amount of airflow through to the lid interior, the vent having a circular mount recessed within the front portion and a vent cover pivotably coupled to the mount, the mount having a pair of vent apertures extending through to the lid interior, the vent cover having a pair of wings extending from a central pivot, the pair of wings conforming to a shape of the pair of vent apertures, each vent aperture being sector-shaped;
a handle coupled to the lid body; and
a lip coupled to the lid body, the lip horizontally extending from a lower edge of the sidewall.
